(19) United States
(12) Patent Application Publication
(10) Pub. No.: US 2011/0231514 A1
(43) Pub. Date: Sep. 22, 2011

(54) CONTENT DELIVERY APPARATUS, CONTENT DELIVERY METHOD, CONTENT PLAYBACK METHOD, CONTENT DELIVERY PROGRAM, CONTENT PLAYBACK PROGRAM

(75) Inventors: Yasuo Ohya, Tokyo (JP); Sunao Wada, Kanagawa-ken (JP)

(73) Assignee: KABUSHIKI KAISHA TOSHIBA, TOKYO (JP)

(21) Appl. No.: 13/023,052

(22) Filed: Feb. 8, 2011

(30) Foreign Application Priority Data
Mar. 17, 2010 (JP) 2010-060838

(51) Int. Cl. G06F 15/16

(52) U.S. Cl. 709/217

(57) ABSTRACT

A content delivery apparatus according to an embodiment is a content delivery apparatus connected to a content playback apparatus via a network. The content delivery apparatus includes storage unit, management-information storage unit, and a delivery unit. The storage unit stores a content to be delivered and additional information related to the content. The management-information storage unit stores, for each content, a level index showing a hierarchical relationship between the content and the additional information. The delivery unit delivers, in response to a delivery request from the content playback apparatus, the level index of the requested content to the content playback apparatus. In addition, the delivery unit read the additional information of the requested content referring to the level index and delivers the additional information. Furthermore, the delivery units read the requested content from the storage unit and delivers the requested content to the content playback apparatus.

### CROSS-REFERENCE TO RELATED APPLICATION(S)

This application is based upon and claims the benefit of priority from the prior Japanese Patent Application No. 2010-060838, filed on Mar. 17, 2010, the entire contents of which are incorporated herein by reference.

### FIELD

The embodiments described herein relate to a content delivery apparatus, a content delivery method and a content delivery program for delivering, via a network, contents such as moving images, music clips, and still images, and also relate to a content playback method and a content playback program.

### BACKGROUND

In an existing video delivery system, a user accesses a video delivery site on a network such as the Internet, and selects and views a desired one of contents uploaded to the site.

Among the various video delivery techniques using the Internet, there is a technique that allows the user who views a moving image to add comment information to the moving image. This technique is used for allowing an instructor and a student of a class to exchange comments while viewing the moving image of a learning material (see JP, P2005-236621A). This technique is known as the “video annotation.”

According to the aforementioned technique, a user viewing a content has no choice but to select either displaying or not displaying a comment related to the content. In addition, if the class has plural instructors and plural students, it is difficult to know which student gives a comment to which instructor.

### BRIEF DESCRIPTION OF THE DRAWINGS

FIG. 1 illustrates the configuration of a content delivery system according to an embodiment of the invention.

FIG. 2 illustrates a level index of a content.

FIG. 3 illustrates an example of a hierarchical structure of metadata.

FIG. 4 illustrates an example of a GUI (Graphical User Interface) screen displayed by a terminal.

FIG. 5 illustrates how to register a content.

FIG. 6A and FIG. 6B illustrates how to register additional information.

FIG. 7A and FIG. 7B illustrates how to deliver a content with the additional information related thereto.

FIG. 8 illustrates an example of a service using the content delivery system.

FIG. 9 illustrates the configuration of a terminal computer.

FIG. 10 illustrates the configuration of a server computer.

### DETAILED DESCRIPTION

According to one embodiment, a content delivery apparatus includes a storage unit, a management-information storage unit, a receiver, and a delivery unit. The storage unit stores a content and additional information related to the content. The management-information storage unit stores, for each content, a level index showing a hierarchical relationship between the content and the additional information. The receiver receives a delivery request sent from a content playback apparatus via a network and specifying the content. The delivery unit delivers, in response to the delivery request, the specified content, the additional information related to the specified content, and the level index of the specified content via the network to the content playback apparatus that has sent the delivery request.

According to one embodiment, a content delivery method: stores a content and additional information related to the content; stores, for each content, a level index showing a hierarchical relationship between the content and the additional information; receives a delivery request sent from a content playback apparatus via a network and specifying the content; and delivers, in response to the delivery request, the specified content, the additional information related to the specified content, and the level index of the specified content via the network to the content playback apparatus that has sent the delivery request.

According to one embodiment, a content playback method; transmits a delivery request specifying a content via a network to a content delivery apparatus; receives the content, additional information related to the content, and a level index delivered from the content delivery apparatus in response to the delivery request, the level index showing a hierarchical relationship between the content and the additional information, the level index including a display start time and a display duration to display the additional information in such a manner that the additional information is superimposed on the content; accepts specification of the additional information, which is to be displayed; and displays the specified additional information in such a manner that the additional information is superimposed on the content on the basis of the display start time and the display duration contained in the level index.

According to one embodiment, a content delivery program is configured to enable a computer including a CPU (Central Processing Unit), a ROM, a RAM, an auxiliary storage, an input device, a display, and a communication I/F (Interface) connecting the computer to a network to function as the content delivery apparatus described above.

According to one embodiment, a content playback program is configured to enable a computer including a CPU (Central Processing Unit), a ROM, a RAM, an auxiliary storage, an input device, a display, and a communication I/F (Interface) connecting the computer to a network to execute the content playback method described above.

A content delivery system according to an embodiment of the invention is described by referring to the drawings.

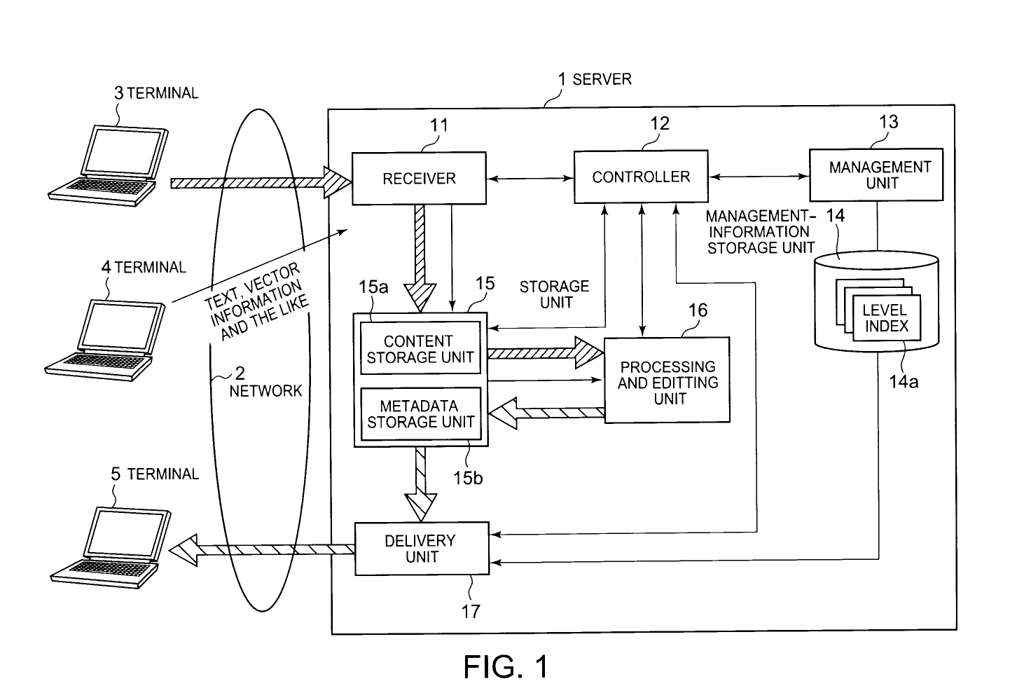

FIG. 1 illustrates the configuration of a content delivery system.

The content delivery system includes a server computer (hereinafter simply referred to as “server”) 1 that delivers a moving image and also includes plural client computers (hereinafter simply referred to as “terminals”) 3 to 5 that are connected to the server 1. The server 1 is located in a center for processing, editing, and delivering videos, and serves as a content delivery apparatus. The terminals 3 to 5 are connected to the server 1 via a network 2 such as the Internet and a LAN, and serve as content playback apparatuses. In addition, the terminals 3 to 5 serve as apparatuses to register an original content and additional information such as descriptions, questions, answers, and comments in the server 1.

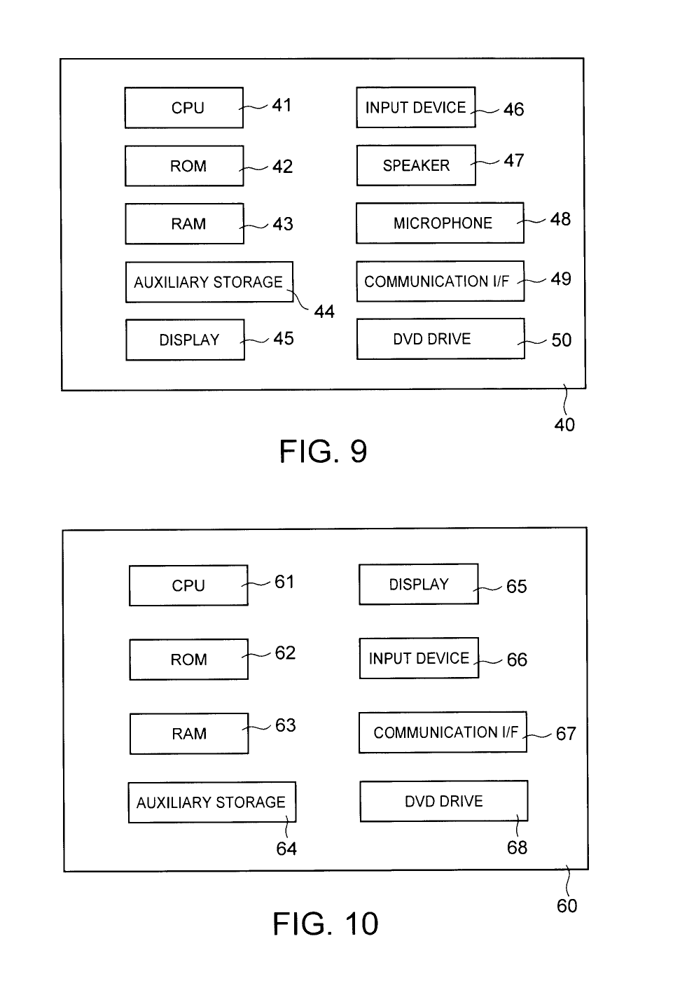

To begin with, the terminals are described. As FIG. 9 shows, each of the terminals 3 to 5 is a personal computer 40 equipped with the following hardware components: a CPU (Central Processing Unit) 41, a ROM (Read Only Memory) 42, a RAM (Random Access Memory) 43, an auxiliary storage 44, a display 45, an input device 46, a speaker 47, a microphone 48, a communication I/F (Interface) 49 that is connected to the network 2, and a DVD drive 50. Specifically, for example, the auxiliary storage 44 is a hard disk drive, and the input device 46 includes a keyboard and a mouse.

A Special software to view and register a content as well as to register additional information is installed in each of the terminals 3 to 5. With the special software, users can view original videos (hereinafter simply referred to as “original content”) together with their related additional information superimposed thereon. In addition, the special software allows users to register, in the server 1, not only an original content but also additional information related to the original content. The special software also allows users to view a composite video content, which will be described later.

The special software, namely a program, to allow the terminals 3 to 5 to execute the functions of the embodiment described below is stored in computer-readable electronic media, is read from the media by the personal computers 40, and is installed in the personal computers 40. Some examples of the electronic media are such recording media as DVD-ROMs, flash memories, removable media, and the like. Alternatively, the program may be stored as a whole in a different computer connected via the network 2, or components of the program may be stored dispersedly in different computers connected likewise. In these cases, the program may be downloaded from the different computer, or computers storing the special software program and then installed in the personal computers 40

The additional information is information that is related, either directly or indirectly, to the original content. Some examples of additional information are descriptions of the original content, questions to the descriptions, and answers to the questions. For example, the descriptions are directly related to the original content. The questions are related directly to the descriptions and indirectly to the original content. If the additional information is text that is to be displayed by being superimposed on the original content, some information is further needed on where in the original content to display the text, when to start displaying the text, and how long the displaying is to continue. Such information related to the additional information is referred to as auxiliary information. The auxiliary information relates the original content to the corresponding additional information. The additional information includes not only text but also audio or vector information such as line drawing.

If a browsing software such as a general-purpose web browser (hereinafter referred to as “general-purpose viewer”) is installed in the terminals 3 to 5, the users can view both of the original content and the composite video content delivered from the server 1. Without the special software, however, the users of the terminals 3 to 5 cannot view the original content with other additional information specified arbitrarily by the user superimposed thereon.

The terminal 3 is used for uploading the original content to the server 1. The terminal 4 is used for uploading additional information to the server 1. The terminal 5 is used for viewing the original content and additional information. For the simplicity's sake, the terminals 3 to 5 in FIG. 1 have their respective unique functions. With the special software program installed therein, however, each of the terminals 3 to 5 can execute all of the functions mentioned above.

The special software allows the user to access the server 1 if information on the user that has been registered in the server 1 is sent to the server 1. A specific example of such information on the user is a user ID.

The special software makes each of the terminals 3 to 5 function as an apparatus to transmit the following requests to the server 1; 1) delivery requests to deliver the original content, the composite video content, or both of the original content and the corresponding additional information, all of which are stored in the server 1; 2) registration requests to register, in the server 1, additional information related to the content being viewed; and 3) registration requests to register, in the server 1, the original content, or both of the original content and the corresponding additional information.

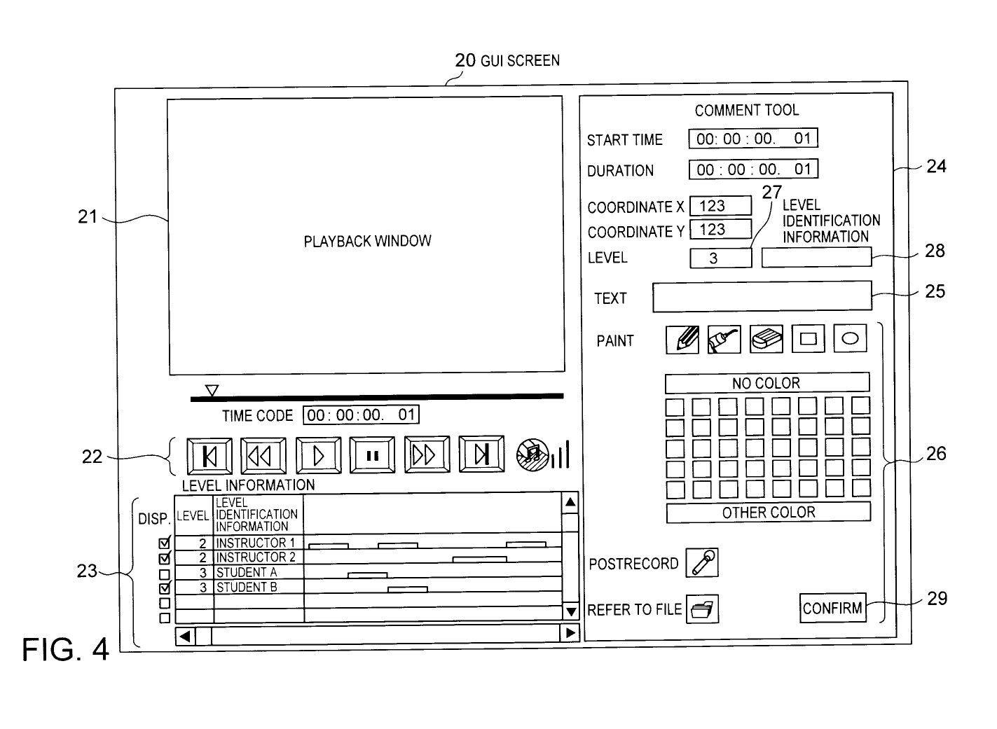

In addition, the special software makes each of the terminals 3 to 5 function as a playback apparatus to execute the following actions; 1) receiving an original content, additional information, and a level index, all of which are delivered from the server 1 in response to the delivery requests; 2) receiving instruction to specify the additional information that is to be displayed when the received original content are reproduced; 3) playing an original content together with specified the additional information superimposed on the original content in a playback window 21 of a graphic user interface screen (hereinafter referred to as “GUI screen”) 20 (see FIG. 4), which will be described in detail later.

The special software makes the GUI screen 20 shown in FIG. 4 appear on the display 45 of each of the terminals 3 to 5.

The GUI screen 20 displays: the playback window 21; an operation unit 22 that is operative to play, rewind the playback, forward the playback, pause, and execute other actions; a field 23 for level information; a comment tool window 24; and the like. The playback window 21 displays the original content singularly or together with the corresponding additional information superimposed thereon. The field 23 for level information displays, for each additional information, the level of the additional information, the name or the ID of the user who has registered the additional information, and how long the additional information should be displayed. In addition, the field 23 for level information displays the checkboxes to designate which the additional information should be displayed.

The comment tool window 24 is a window for the user to create additional information such as descriptions and questions. The comment tool window 24 has various entry fields to input various kinds of data used to superimpose the additional information on the original content. The comment tool window 24 has a field for the start time, a field for the duration, a field for the coordinate X, and a field for the coordinate Y. In addition, the comment tool window 24 has a text field 25, a field 27 for the level, and a field 28 for the information to identify the level. The start time, meaning when to start the superimposition of the additional information on the corresponding original content, is inputted into the field for the start time. In this embodiment, the time code acquired from the original content is automatically inputted into the field for the start time. What is inputted into the field of the duration is how long the displaying of the additional information should continue. Both of the fields for the coordinates X and Y have information on the position where in the playback window 21 the additional information should be displayed. If the additional information is text, the text to be displayed is inputted into the text field 25. The field 27 for the level is provided to input a number representing the level of the additional information to be newly added. Specifically, the number to be inputted is one representing one level below the level of the original content or of the existing additional information that the additional information is to be added to. The field 28 for the information to identify the level receives automatic input of either the name or the ID of the user who is currently logged in the particular terminal. The comment tool window 24 also has, in addition to the field 25 for inputting the text, the field 26 which is used to create hand-drawn image information (vector information), to input audio data, and to designate a file to be referred to. In addition, the comment tool window 24 has a confirm button 29.

Next, the server 1 is described. As FIG. 10 shows, the server 1 is a computer 60 equipped with the following hardware components: a CPU 61, a ROM 62, a RAM 63, an auxiliary storage 64, a display 65, an input device 66, a communication I/F 67 that is connected to the network 2, and a DVD drive 68. Specifically, for example, the auxiliary storage 64 is a hard disk drive, and the input device 66 is a keyboard and the like.

As FIG. 1 shows, the server 1 includes a receiver 11, a controller 12, a management unit 13, a management-information storage unit 14, a storage unit 15, a processing and editing unit 16, a delivery unit 17, and the like. These units are implemented by the hardware of the server 1 and a program installed in the server computer.

To enable a computer to execute the functions of these units of the server 1 (detailed descriptions of the functions will be given later), the program is stored in a computer-readable electronic medium and read from the electronic medium by the computer. Some examples of the electronic medium are such recording media as DVD-ROMs, flash memories, and other types of removable media. Alternatively, the program may be stored as a whole in a different computer connected via the network 2, or components of the program may be stored dispersedly in different computers connected likewise. In these cases, the program may be downloaded from the different computer, or computers storing the program, and then installed in the computer.

If user information that the server 1 receives from one of the terminals 3 to 5 via the network 2 is already registered, the server 1 registers the original content or the additional information related to the original content uploaded by that one of the terminals 3 to 5. Alternatively, the server 1 transmits, to the terminal from which the delivery request comes, the already-registered original content, the already-registered composite video content, or the already-registered original content together with the additional information and the level index.

The receiver 11 receives requests from the terminals 3 to 5. Some of the requests from the terminals 3 to 5 are: delivery requests to request the delivery of the content; registration requests to request the registration of the original content; registration requests to request the registration of new additional information related to the original content being viewed.

The controller 12 controls other units in response to the various kinds of requests received by the receiver 11. For example, if a delivery request comes from the terminal 5, the controller 12 controls the management unit 13, the storage unit 15, the processing and editing unit 16, and the delivery unit 17 so that the requested original content together with the additional information and the level index related to the original content can be delivered to the terminal 5.

The function of the storage unit 15 is implemented by a storage device such as a hard disk drive. The storage unit 15 includes a content storage unit 15a and a metadata storage unit 15b. The content storage unit 15a stores the original content uploaded, for example, from the terminal 3 and the composite video content created by synthesizing the original content and the additional information by the processing and editing unit 16.

The metadata storage unit 15b stores the additional information related either directly or indirectly to the original content. Accordingly, the storage unit 15 stores both of the original content and the additional information related to the original content.

The management unit 13, controlled by the controller 12, creates level indices 14a each showing the hierarchical structure including the original content and the additional information related to the original content. Thus a level index 14a is created for each original content. The management unit 13 makes the management-information storage unit 14 store the level indices 14a. In addition, the management unit 13, controlled by the controller 12, reads out, from the management-information storage unit 14, the level index 14a corresponding to the requested original content. Then, the management unit 13 transfers the readout level index 14a to the delivery unit 17.

The function of the management-information storage unit 14 is implemented by a storage device such as a hard disk drive. The management-information storage unit 14 stores the level index 14a for each original content.

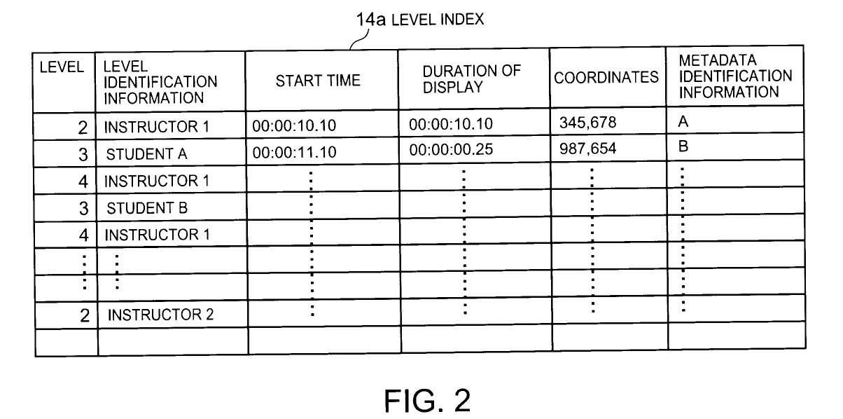

As FIG. 2 shows, each level index 14a records, for each additional information, its level, level identification information, start time, duration of display, coordinates, and metadata identification information. In short, the level index 14a includes information on the level of the additional information and auxiliary information on the additional information.

The level of the original content is defined as the highest level. The levels are numerically expressed using such numbers as “1,” “2,” “3,”. . . Specifically, the number “1” means the first level, the level of the original content. The number “2” means the second level, the level of the additional information related directly to the first level. The number “3” means the third level, the level of the additional information related directly to the second level. In general terms, a number “n” means the level of the additional information related directly to the level “n-1.” To put it differently, the level of the additional information is one level lower than the level of either the original content or the existing additional information that the additional information is directly related to.

The level identification information is information to identify the user who registered the additional information, and specifically is either the user ID or the user name. In some cases, there may be more than one speaker in a single level, so the level identification information is used to distinguish one speaker from the others. The start time is the time to start the additional information and is related to the time code of the corresponding original content. The duration of display is how long the displaying of the additional information continues. The coordinates are information on the position where the additional information is superimposed on the corresponding original content. The metadata identification information is the file name with which the additional information—text, vector information, audio, or the like—is stored. The metadata identification information relates the original content to the files of the corresponding additional information stored in the metadata storage unit 15a.

In a level index 14a, the additional information is classified in a hierarchical order on the basis of the level of the target item (either the original content or the existing additional information) to which the additional information is added.

In short, the level index 14a is an index table with a hierarchical structure where the original content is in the first level, the additional information related directly to the original content is in the second level, and the additional information related directly to the additional information in the second level is in the third level.

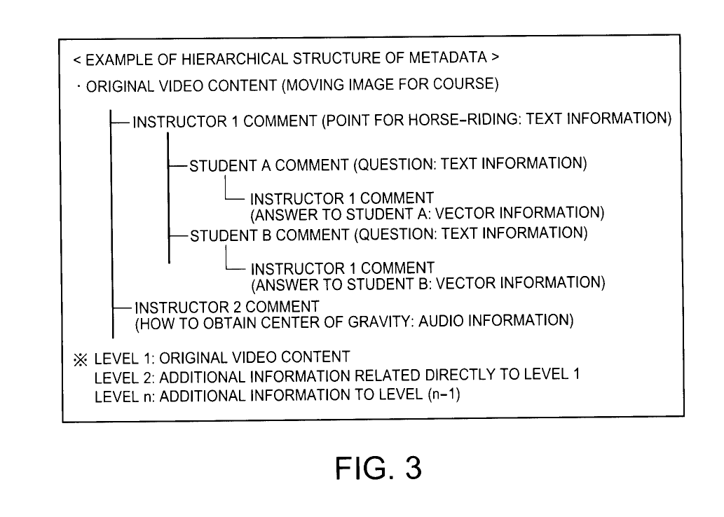

FIG. 3 shows an example of a hierarchical structure where the original content and the additional information related thereto are classified in accordance with the level index 14a.

The processing and editing unit 16 synthesizes the original content with the additional information, and thus creates a composite video content that the users can view using a general-purpose viewer. The processing and editing unit 16 stores the composite video content thus created in the content storage unit 15a.

The delivery unit 17 transmits the level index 14a of the original content to be delivered, via the network 2 to the terminal which a delivery request originates from, the level index 14a having been sent from the management-information storage unit 14. In addition, the delivery unit 17, controlled by the controller 12, reads out all the additional information in all the levels which is related to the delivery-target original content and which is stored in the metadata storage unit 15b. Then, the delivery unit 17 transmits the readout additional information to the terminal which the delivery request originates from. Furthermore, the delivery unit 17 reads out the delivery-target original content stored in the content storage unit 15a, and then transmits the readout original content to the terminal which the delivery request originates from.

To put it differently, in response to a delivery request received from the terminal by the receiver 11, the delivery unit 17 transmits, to the terminal that has requested the original content, the level index 14a related to the requested original content. In addition, by referring to the level index 14a, the delivery unit 17 reads out, from the metadata storage unit 15b, the additional information related to the requested original content, and also reads out, from the content storage unit 15a, the requested original content. Then, the delivery unit 17 transmits, via the network 2, both of the readout additional information and the readout original content to the terminal that has requested the original content.

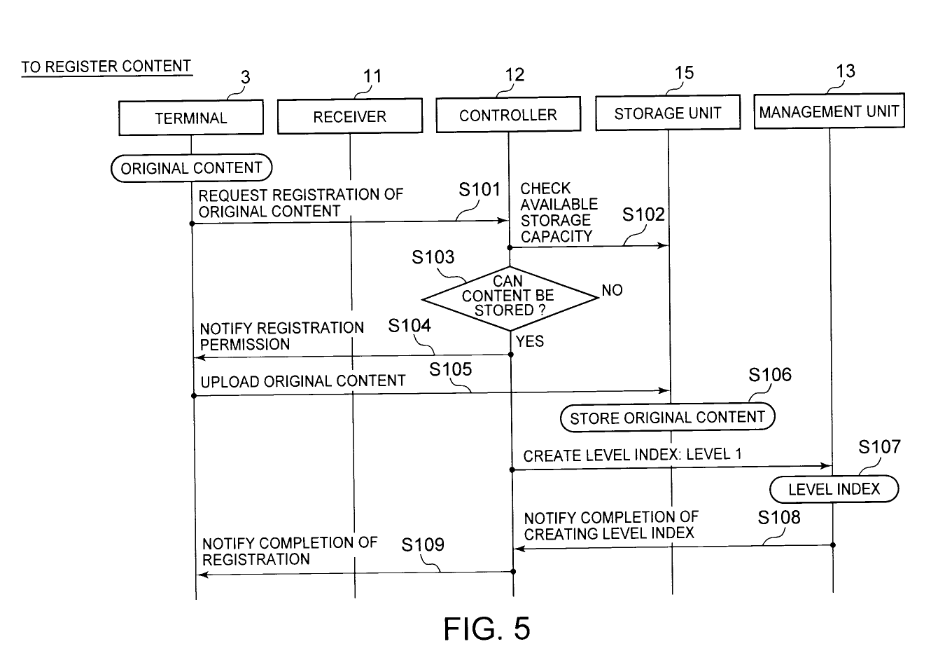

Next, how the content delivery system works is described by referring to FIGS. 5 to 8.

To begin with, the procedure to register the original content is described by referring to FIG. 5. Description is given of the case where the original content stored in the terminal 3 is uploaded to the server 1 and then the server 1 registers the uploaded original content.

As a preliminary process, the user runs the special software on the terminal 3. Then, the user inputs the URL of the server 1 through the screen of the special software, and thus accesses the server 1 on the network 2. Then, the user logs in the server 1 as a user authorized to upload the original content. Thus, the server 1 recognizes the terminal 3 as a party authorized to upload the original content.

Then, the terminal 3 requests the controller 12 of the server 1 to register the original content (step S101). Upon receiving the registration request, the controller 12 checks up the available storage capacity of the storage unit 15 (step S102), and compares the volume of the original content with the available storage capacity. If the available storage capacity of the storage unit 15 is larger than the volume of the original content, the controller 12 determines that the storage unit 15 can store the original content (Yes at step S103). Then, the controller 12 notifies the terminal 3 of a message meaning that the registration is permitted (step S104).

Upon receiving the notification of permission for registration, the terminal 3 uploads the original content to the server 1 (step S105). The server 1 stores the uploaded original content to the content storage unit 15a (step S106).

In the meanwhile, the controller 12 notifies the management unit 13 of the fact that this original content is registered for the first time. and controls the management unit 13 so that the management unit 13 creates a new level index 14a for the original content.

The management unit 13, controlled in the above-described way, creates the new level index 14a in the management-information storage unit 14 (step S107), and registers the original content in the first level in the newly-created level index 14a.

Once the registration is finished, the management unit 13 notifies the controller 12 of the fact that the level index 14a for the uploaded original content has been created (step S108). Upon receiving this notification, the controller 12 notifies, by sending a message, the terminal 3 of the fact that the registration is completed (step S109).

During the registration of the original content, a log-in procedure, a user authentication, accounting management, and the like may be done between the terminal 3 and either the receiver 11 or the controller 12 of the server 1.

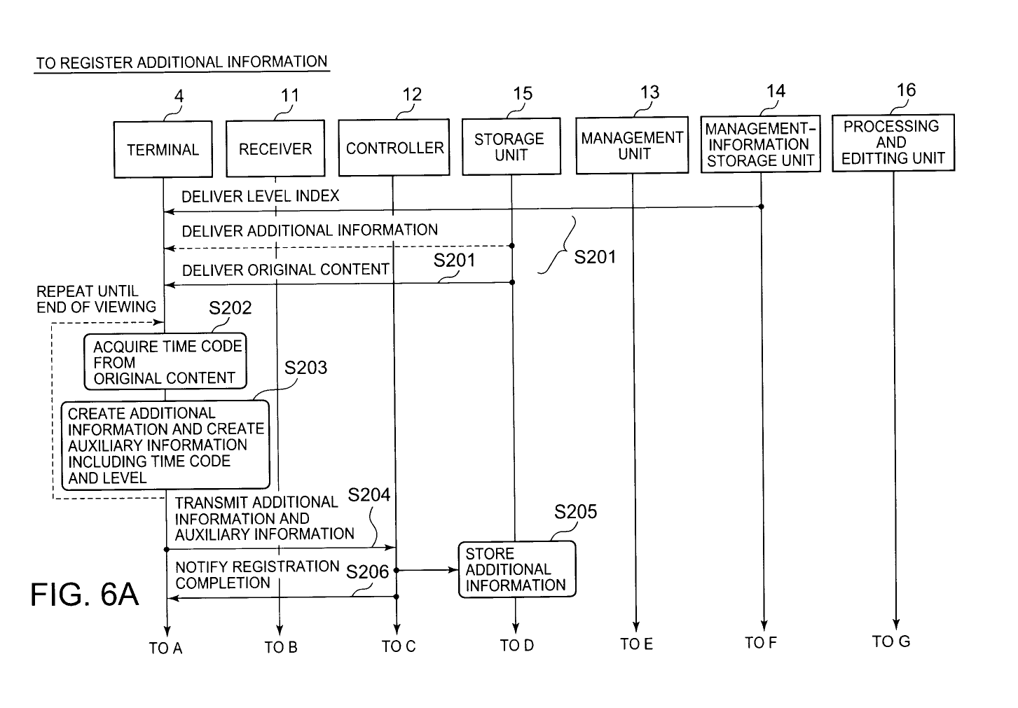

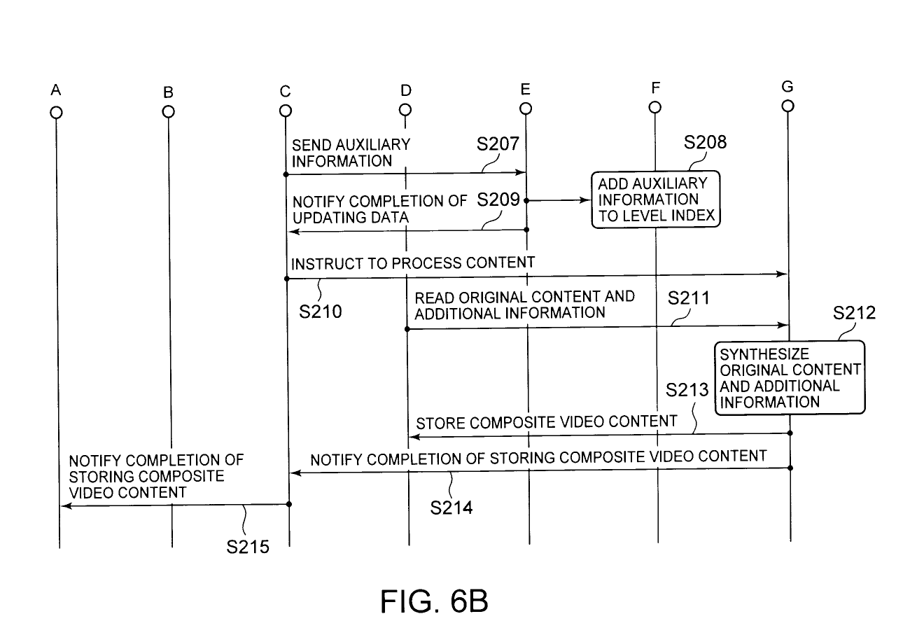

Next, by referring to FIGS. 6A and 6B, description is given of the procedure to allow a user viewing a content to post, from the terminal, the additional information concerning the content being viewed. That is, the procedure to register the additional information is described. The description is given of the case where the terminal 4 is used for the registration of the additional information in the server 1.

In this system, when a user views the content, the server 1 delivers the content, the related additional information, and the level index 14a corresponding to the content to the terminal 4 that the user uses (step S201).

If the level index 14a corresponding to the content that the user is to view has only an item of the first level, the server 1 delivers only the original content to the terminal 4. Accordingly, the user can view only the original content. If the level index 14a has items of different levels, the server 1 delivers the original content, the related additional information, and the level index 14a to the terminal 4. Accordingly, the user can view both of the original content and the additional information superimposed on the original content.

Note that the special software program is running on the terminal 4 and the GUI screen 20 is displaying the original content. The special software continuously acquires the time code from the original content being played (step S202).

For registering the additional information related to the original content, the user creates the additional information and the auxiliary information for the additional information on the comment tool window 24 in the GUI screen 20. The additional information may be text, audio, vector information, an image, or the like and is created in a file format that the special software supports. In addition, the user enters, into the predetermined fields in the comment tool window 24, the information needed to display the additional information, such as the duration of how long the additional information should be displayed, and the coordinates indicating where the additional information should be displayed in the playback window 21. The start time for displaying the additional information is put into the field for the start time by the special software using the time code acquired from the original content. If the additional information is text, the text is inputted into the text field 25.

What is inputted into the field 27 for the level is a number representing the level immediately below the level of the target item (either the original content or the existing additional information) for the addition of the additional information. To put it differently, a number representing the level of the additional information to be registered is inputted into the field 27 for the level. For example, if the additional information is added to the original content, the level of the additional information is the second level, the level immediately below the level of the original content. Accordingly, a number “2” is inputted into the field 27 for the level.

After the creation of the additional information, the user presses the confirm button 29. Then, the special software creates both a file of the additional information and the auxiliary information related to the additional information (step S203). The auxiliary information is the information inputted through the comment tool window 24 shown in FIG. 4, and includes the start time, the duration, the coordinates indicating the position where the additional information should be displayed, the level of the additional information newly added, and the link information of the additional information itself. The additional information and the auxiliary information thus created are temporarily stored in either the RAM 43 of the terminal 4 or the auxiliary storage 44 thereof. If the user continues to view the original content and creates new additional information, the user repeats the series of above-described operations. The user thus creates the new additional information and its auxiliary information, and temporarily stores these newly-created items in either the RAM 43 of the terminal 4 or the auxiliary storage 44 thereof. The position where the additional information should be added is not necessarily determined to a single position. There may be various possible positions. Once the user finish viewing the original content, the user transmits, via the network 2 to the server 1, the additional information and the auxiliary information both of which are stored in either RAM 43 or the auxiliary storage 44. This transmission is done by the special software (step S204).

In the server 1, when the receiver 11 receives the transmitted additional information and auxiliary information, the controller 12 stores the additional information in the metadata storage unit 15b of the storage unit 15 (step S205).

Upon storing the above-mentioned additional information, the controller 12 transmits a notification of registration completion to the terminal 4 (step S206), and sends the auxiliary information to the management unit 13 (step S207).

The management unit 13, using the auxiliary information received, adds a new record (row) in the corresponding level index 14a in the management-information storage unit 14 (step S208). In addition, the management unit 13 outputs a notification of data-update completion to the controller 12 (step S209), and thus notifies the controller 12 of the fact that the data are updated.

Upon receiving the notification of data-update completion from the management unit 13, the controller 12 detects the fact that the registration of either a new original content or new additional information is now possible.

After that, to enable a user of the general-purpose viewer to view the content, the controller 12 controls the processing and editing unit 16 so that the processing and editing unit 16 synthesizes the original content with the additional information (step S210). With this control, the processing and editing unit 16 reads out, from the storage unit 15, both of the original content and the additional information (step S211). Then, the processing and editing unit 16 synthesizes the original content and the additional information (step S212) to create a composite video content of a file type that can be viewed using a general-purpose viewer.

The processing and editing unit 16 stores the composite video content in the content storage unit 15a of the storage unit 15 (step S213). Then, by sending a notification of storage completion, the processing and editing unit 16 notifies the controller 12 of the fact that the composite video content is stored in the storage unit 15 (step S214).

If the user does not view the content with a general-purpose viewer, the processing and editing unit 16 does not have to create the composite video content.

Once the series of tasks are finished, the controller 12 notifies the terminal 4 of the fact that the storing of the composite video content is finished (step S215). From then onward, the terminal 4 allows the user to view the composite video content with not only the special software but also a general-purpose viewer. It is, however, not possible for the terminal 4 to allow the user to view, with any general-purpose viewer, the original content with other additional information superimposed thereon.

When the terminal 4 registers the additional information related to the original content being viewed, a log-in procedure, a user authentication, accounting management, and the like may be done between the terminal 4 and either the receiver 11 or the controller 12 of the server 1. Note that a log-in procedure, a user authentication, accounting management, and the like may be different from those performed when the user intending to view the original content logs in the server 1.

In the description given thus far, a case of registering the original content in the server 1 by means of the terminal 3 and a case of registering the additional information in the server 1 by means of the terminal 4 are described separately. If, however, a user of a single terminal registers both of the original content and the additional information, the user of the single terminal may register both items simultaneously instead of registering the two items at two separate times. That is, each of the terminals 3 to 5 may be configured to send the original content, the additional information, and the auxiliary information to the server 1 by a single operation. In addition, the server 1 may be configured to receive all of these items, and to register the original content and the additional information. With such configurations, each of the terminals 3 to 5 can provide the user with a more user-friendly operation environment.

Next, description is given of the procedure that the system of this embodiment allows a user to view the original content with the additional information superimposed thereon. Firstly, the outline of the operation is described. Description is given of the case where a user of the terminal 5 views the original content together with the related additional information.

The special software program has been installed in the terminal 5. The user starts running the special software program on the terminal 5, and then inputs a predetermined URL through the special software. Then, the special software allows the terminal 5 to access the server 1 of the content delivery site. Thus, the terminal 5 makes the site appear on the screen of the special software.

Then, the user specifies a desired content in the site displayed on the screen of the special software. Then, the special software downloads, from the server 1, the level index 14a of the specified content, the related additional information. Furthermore, the special software downloads, from the server 1, the specified original content. The special software makes the playback window 21 of the GUI screen 20 display the original content with the related additional information superimposed thereon.

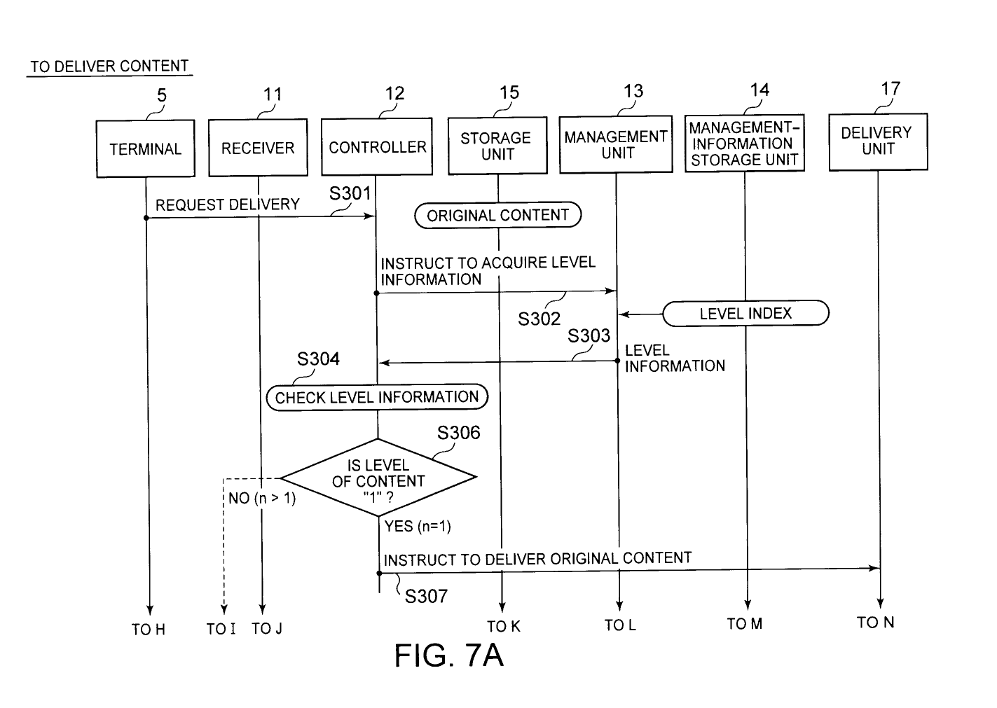

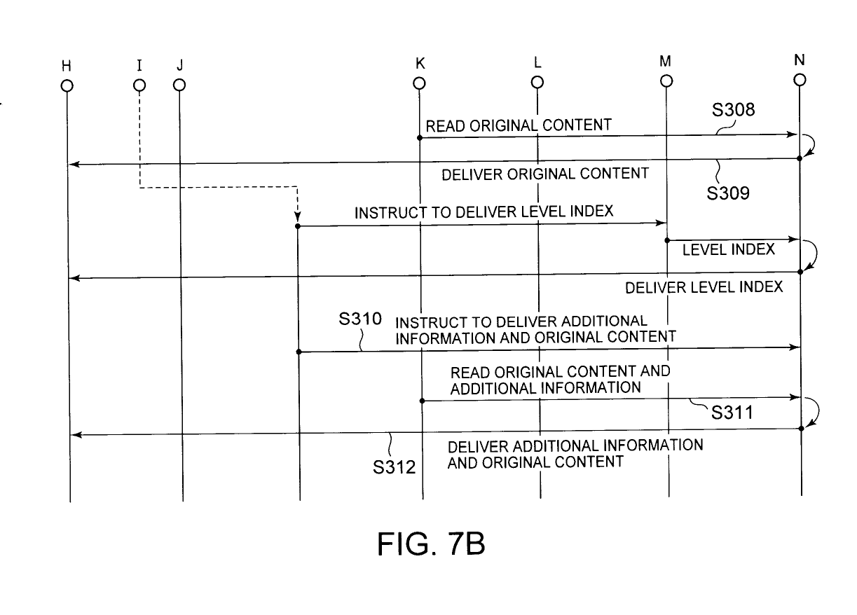

By referring to FIGS. 7A and 7B, detailed description is given of the operation of the system of this embodiment to deliver a content to the terminal 5.

When the user specifies a desired content, the special software transmits, to the controller 12 of the server 1, a delivery request specifying the desired content (step S301).

Upon receiving the delivery request, the controller 12 of the server 1 sends, to the management unit 13, an instruction to acquire the level information of the requested content (step S302). The above-mentioned level information of the requested content is the information on the numbers of the levels in the level index 14a corresponding to the requested original content and which represent the levels of both of the original content and the related additional information.

The management unit 13 acquires the level information from the appropriate one of the level indices 14a stored in the management-information storage unit 14. Then, the management unit 13 sends the acquired level information to the controller 12 (step S303).

The controller 12 checks up the acquired level information to determine how many levels are included in the content (step S304). Specifically, what is determined here is whether the content includes only a single level or plural levels.

If the requested content includes only a single level (Yes at step S306), there is no additional information. Accordingly, the controller 12 instructs the delivery unit 17 to deliver only the requested original content to the terminal 5 (step S307). Upon receiving the instruction, the delivery unit 17 reads out the original content from the storage unit 15 (step S308), and delivers the readout original content to the terminal 5 (step S309).

If, on the other hand, the requested content includes plural levels (No at step S306), the additional information are added to the original content. Accordingly, the controller 12 instructs both of the management-information storage unit 14 and the delivery unit 17 to deliver the relevant level index 14a to the terminal 5. The management-information storage unit 14 transfers the level index 14a to the delivery unit 17, and then the delivery unit 17 delivers the level index 14a to the terminal 5 via the network 2.

In addition, the controller 12 instructs the delivery unit 17 to deliver, to the terminal 5, all the additional information related to the specified original content along with the specified original content (step S310). Upon receiving this instruction, the delivery unit 17 reads out, from the storage unit 15, both of the original content and the additional information (step S311), and delivers the readout items to the terminal 5 via the network 2 (step S312).

In the terminal 5, the special software receives the original content sent from the delivery unit 17. If there are plural levels for the content, the special software receives the level index 14a, the additional information, and the original content. On the basis of the received level index 14a, the special software displays the information on the additional information the field 23 for level information of the GUI screen 20 display. The user refers to the level information on the additional information displayed on the GUI screen 20, and thus specifies the additional information that the user wants to display, by putting a mark or marks in the checkboxes of display. Then, the special software refers to the level index 14a, and displays the specified additional information in such a manner that the specified additional information is superimposed on the original content. The displaying of each specified additional information is started at the start time described in the level index 14a, continues for the duration described therein, and is placed at the display position described therein. Thus, the additional information that the user wants to display appears on the playback window 21 in such a manner that the additional information is superimposed on the original content. Note that if the additional information is audio, the sound is outputted from the speaker 47 of the terminal 5.

As described above, when the server 1 delivers the additional information to the terminal 5, all the additional information in all the levels related to the original content are transmitted by referring to the level index 14a. Accordingly, once starting viewing the original content, the user does not have to stop viewing it to change the additional information to be displayed. To this end, the user uses the checkboxes of display. If the user specifies different additional information, the special software changes the additional information to be displayed.

If the terminal 5 receives the level index 14a and the additional information before receiving the original content, the terminal 5, while receiving the original content, can play the original content with the additional information superimposed thereon. Accordingly, the playback of the original content can be started in a shorter time from the transmission of the delivery request. If the terminal 5 receives the level index 14a and the additional information after receiving the original content, the terminal 5 cannot start playing the original content until the receiving of all the data of the original content, those of level index 14a and of the additional information is completed.

Apart from the user's logging in the terminal 5, when the user views the content, a log-in procedure, a user authentication, accounting management, and the like may be done between the terminal 5 and either the receiver 11 or the controller 12 of the server 1.

The description above is given of the case where the user of the terminal 3 uploads the original content to the server 1, the user of the terminal 4 uploads the additional information to the server 1, and the user of the terminal 5 views the original content together with the additional information. If, however, the special software program is installed in each of the terminals 3 to 5, any of the terminals 3 to 5 can perform all the functions described above.

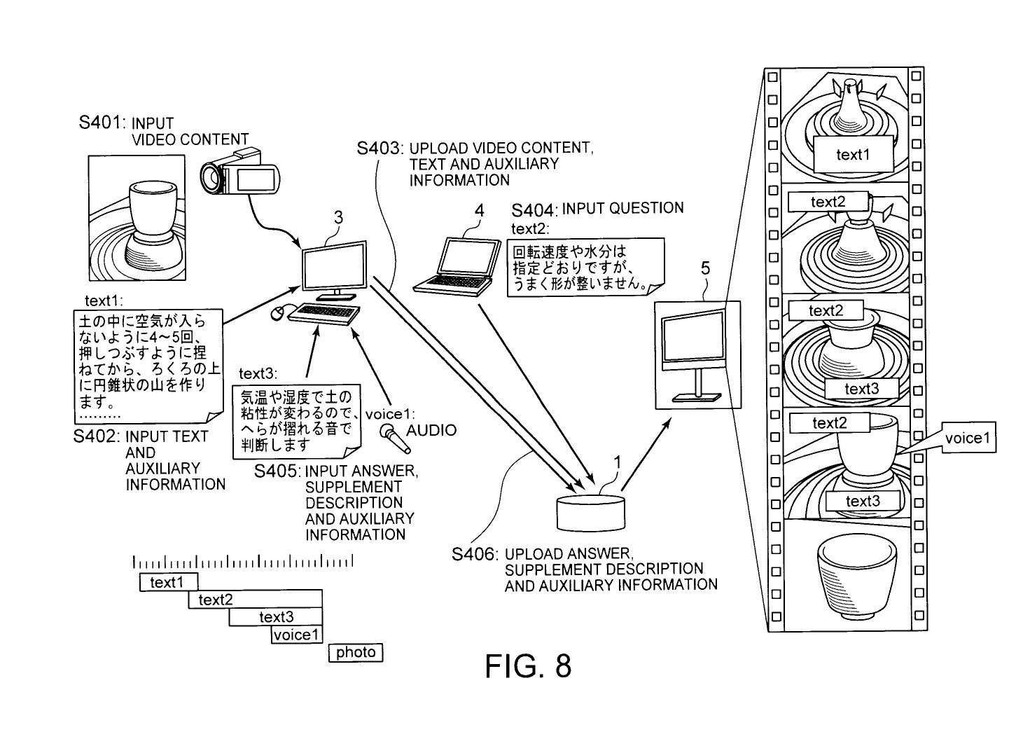

Lastly, an example of a service using the system of this embodiment is described by referring to FIG. 8. Specifically, a pottery making course is described.

As FIG. 8 shows, an instructor inputs the original video content into the terminal 3 (step S401), and temporarily stores the original content in the hard disk drive of the terminal 3. The original content is a learning material used in the pottery making course. For example, the material is a moving image shot with a movie camera.

Subsequently, the instructor inputs the text for description through the GUI screen 20 of the special software program running on the terminal 3. Thus, the instructor creates text data which is the additional information. Then, the instructor inputs the time when the displaying of the text should start, how long the displaying of the text should continue, where the text should be displayed, and the like. Thus, the instructor creates the auxiliary information (step S402). The special software uploads, to the server 1, the original content, the additional information, and the auxiliary information (step S403). Thus, the original content, the additional information (i.e., the text for description), and the auxiliary information for the additional information are stored in the server 1. Note that the additional information and the auxiliary information are stored in the server 1 as an electronic manual ver.1.

Subsequently, a student of this course accesses the server 1 with the terminal 4, and views both of the moving image of the learning material (i.e., the original content) and the electronic manual ver.1. While the student is viewing the original content and the electronic manual ver.1, a question may occur to the student. Then, the student registers, in the server 1, the question as the additional information (step S404).

In response to the additional information (question) registered by the student, the instructor inputs answering text through the terminal 3, and records an audio supplemental description with the microphone 48. That is, the instructor creates new additional information. In addition, the instructor inputs, through the comment tool window 24 of the GUI screen 20, how long the displaying of the text should continue, when the outputting of the audio supplemental description should start, and the like (step S405). The special software creates the auxiliary information on the basis of the data inputted through the comment tool window 24. The special software uploads, to the server 1, the file of the text data, the file of the audio data, and the auxiliary information (step S406). The server 1 stores the file of the text data and the file of the audio data in the metadata storage unit 15b, and updates the level index 14a on the basis of the auxiliary information. Thus, the electronic manual ver.1 is revised, and an electronic manual ver.2 is created.

The other students of the course can view the communication done between the instructor and the questioner student while the electronic manual is upgraded from ver. 1 to ver. 2. To this end, each of the other students uses the special software program running on the terminal 5, and specifies the additional information of the electronic manuals ver.1 and ver.2 with the special software program.

According to the content delivery system of the above-described embodiment, every time the original content is uploaded to the server 1, the server 1 creates the level index 14a with the uploaded original content being in the first level. In addition, the server 1 manages, using the level index 14a, the levels of the additional information related either directly or indirectly to the original content. Specifically, the level of the additional information related directly to the video content is defined as the second level, and the level of the additional information related directly to the additional information in the second level is defined as the third level. Thus, the question of the student to the description of the instructor and the answer of the instructor to the question of the student can be added under the original content. Accordingly, the details of the communication between the instructor and the questioner student can be viewed.

As has been described above, the level of the video content of the pottery making course is defined as the first level, and the instructor creates an electronic manual by adding description (additional information in the second level) to the video content while viewing the video content. Viewing the video content and the electronic manual, the student adds a question (additional information in the third level). Then, the instructor adds an answer (additional information in the fourth level) to the question of the student. In this way, the electronic manual is upgraded repeatedly. Hence, the content delivery system of this embodiment has another advantageous effect, which is accumulation of expertise.

Consequently, if content delivery is performed via the network 2, the system of this embodiment can support a form of service such that plural instructors describes the content while plural students using the terminals of the content-delivery destinations submit questions while viewing or browsing the content.

In the embodiment described above, in response to a delivery request sent from the terminal 5 to the server 1, the server 1 delivers all the additional information related to the requested original content. Then, the user specifies the additional information that the user wants to display. Then, the special software displays the specified additional information in such a manner that the additional information is superimposed on the original content. The method of delivering the additional information is not limited to the above-described one. The server 1 may be configured to deliver only the additional information specified by the user. For example, the server 1 delivers the level index 14a to the user. Then, on the basis of the level index 14a, the user specifies, with the terminal 5, the additional information that the user wants to view. The additional information that the user wants to view are notified to the server 1. On the basis of the specification sent from the terminal 5, the server 1 delivers, to the terminal 5, both of the additional information specified and the original content. Then, terminal 5 displays the delivered additional information in such a manner that the delivered additional information is superimposed on the original content. Hence, only the selected additional information can be delivered to the terminal 5 of the user. Consequently, the time needed to deliver the additional information can be shortened compared with the case of the above-described embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A content delivery apparatus comprising:
a storage unit configured to store a content and additional information related to the content;
a management-information storage unit configured to store, for each content, a level index showing a hierarchical relationship between the content and the additional information;
a receiver configured to receive a delivery request sent from a content playback apparatus via a network and specifying the content; and
a delivery unit configured to deliver, in response to the delivery request, the specified content, the additional information related to the specified content, and the level index of the specified content via the network to the content playback apparatus that has sent the delivery request.

2. The content delivery apparatus according to claim 1, wherein the delivery unit reads the additional information from the storage unit by referring to the level index, and delivers the additional information to the content playback apparatus.

3. The content delivery apparatus according to claim 1, wherein the additional information includes first additional information related directly to the content, and, different additional information which is other than the first additional information and which is related indirectly to the content.

4. The content delivery apparatus according to claim 3, wherein the different additional information other than the first additional information includes second additional information related directly to the first additional information.

5. The content delivery apparatus according to claim 4, wherein the level index is an index table hierarchically classifying the content, the first additional information related directly to the content, and the second additional information related directly to the first additional information so that the content is in a first level, the first additional information is in a second level, and the second additional information is in a third level.

6. The content delivery apparatus according to claim 1, wherein the level index includes information on a file name, a display start time, a display duration, and a display position of the additional information.

7. The content delivery apparatus according to claim 1, further comprising a processing and editing unit configured to create a composite video content by synthesizing a registered content with registered additional information.

8. The content delivery apparatus according to claim 6, further comprising a management unit,
wherein when the receiver receives an original content and a request for registering the original content sent from a content registration apparatus, the management unit creates a new level index and stores the new level index in the management-information storage unit.

9. The content delivery apparatus according to claim 8, further comprising a management unit,
wherein when the receiver receives a registration request sent from the content registration apparatus and including additional information related to the original content and auxiliary information containing the display start time indicating a time to start displaying the additional information related to the original content in such a manner that the additional information is superimposed on the original content and the display duration indicating a duration to continue displaying the additional information related to the original content, the storage unit stores the received additional information to be added to the original content, and the management unit adds the auxiliary information to the level index.

10. The content delivery apparatus according to claim 1, wherein the delivery unit delivers, to the content playback apparatus, the level index, the additional information, and the content in this order.

11. A content delivery method comprising the steps of:
storing a content and additional information related to the content;
storing, for each content, a level index showing a hierarchical relationship between the content and the additional information;
receiving a delivery request sent from a content playback apparatus via a network and specifying the content; and
delivering, in response to the delivery request, the specified content, the additional information related to the specified content, and the level index of the specified content via the network to the content playback apparatus that has sent the delivery request.

12. A content playback method comprising the steps of:
transmitting a delivery request specifying a content via a network to a content delivery apparatus;
receiving the content, additional information related to the content, and a level index delivered from the content delivery apparatus in response to the delivery request, the level index showing a hierarchical relationship between the content and the additional information, the level index including a display start time and a display duration to display the additional information in such a manner that the additional information is superimposed on the content;
accepting specification of the additional information, which is to be displayed; and
displaying the specified additional information in such a manner that the additional information is superimposed on the content on the basis of the display start time and the display duration contained in the level index.

13. A content delivery program configured to enable a computer including a CPU (Central Processing Unit), a ROM, a RAM, an auxiliary storage, an input device, a display, and a communication I/F (Interface) connecting the computer to a network to function as a content delivery apparatus described in claim 1.

14. A content playback program configured to enable a computer including a CPU (Central Processing Unit), a ROM, a RAM, an auxiliary storage, an input device, a display, and a communication I/F (Interface) connecting the computer to a network to execute the content playback method according to claim 10.
